(19) United States
(12) Patent Application Publication
(10) Pub. No.: US 2015/0082071 A1
(43) Pub. Date: Mar. 19, 2015

(54) Smart Monitoring Apparatus

(71) Applicant: AJINEXTEK CO., LTD., Daegu (KR)

(72) Inventors: Jong Eun Kim, Gyeonggi-do (KR); Gi Sub Hwang, Daegu (KR); Tae Won Kim, Gyeonggi-do (KR); Sang Tae Lee, Daegu (KR); Sung Hyuk Choi, Daegu (KR); Chang Ho Kim, Daegu (KR)

(21) Appl. No.: 14/395,809

(22) PCT Filed: Apr. 23, 2013
(86) PCT No.: PCT/KR2013/003425

§ 371 Date: Oct. 20, 2014

(30) Foreign Application Priority Data
Apr. 27, 2012 (KR) 10-2012-0044814

(51) Int. Cl. G06F 1/28

(52) U.S. Cl. CPC G06F 1/28
USPC 713/340

(57) ABSTRACT

A smart monitoring apparatus and a monitoring method using the apparatus. A smart monitoring apparatus is provided in a PC system to monitor a state of a PC-based embedded controller, the apparatus including: a monitoring block for monitoring a state in the system and creating state information; a logging block for receiving the state information created by the monitoring block and storing the state information in a form of a log in real-time so that the stored log and current state information may be confirmed; and a battery for supplying power to the logging block when an operating system in the system does not operate or power supplied to the system is cut off.

### FIELD OF THE INVENTION

The present invention relates to a smart monitoring apparatus and a monitoring method using the apparatus. More specifically, the present invention relates to a smart monitoring apparatus, in which when a power failure is detected in the power supplied to a PC-based embedded controller, a log for grasping a cause of the power failure is provided, and since a battery is separately provided, a system state can be continuously monitored, stored and confirmed even when the power supplied to the system is cut off or an error occurs in an operation of the OS.

### BACKGROUND OF THE INVENTION

A PC-based embedded controller is generally configured of hardware (H/W) (a CPU, memory, an interface chipset, various function boards, a power and the like) and an operating system (OS, e.g., Microsoft Windows series). A general PC system is embedded with a smart IC therein and monitors a system state in real-time.

That is, such a smart IC is connected to a temperature sensor for measuring temperature of the CPU or temperature of the case in the system and monitors temperature of the CPU or the case in the system in real-time. In addition, the smart IC monitors speeds and operation states of a CPU fan, a case fan and the like and monitors a system power.

Accordingly, a user may confirm a current system state by confirming information on the monitored states. However, since a conventional monitoring apparatus may confirm only the current state information and may not figure out why a problem has been occurred in the system, it is difficult to grasp a cause of the problem occurred in the system.

In addition, although a user may confirm the current state information when the OS operates, if the OS does not operate or the system power has a problem, a host PC may not confirm the current state information, and, furthermore, a cause of a system error cannot be analyzed.

### SUMMARY OF THE INVENTION

Accordingly, required is a smart monitoring apparatus, in which when a problem occurs in the system, a user may analyze a cause of the system problem by confirming log information as well as the current state information, and even when the system power is cut off or the OS has an error, the user may confirm the current state information and the log information and analyze a cause the error.

### Technical Problem

Therefore, the present invention has been made in view of the above problems, and it is an object of the present invention to provide a smart monitoring apparatus, which may sense a state of a PC-based embedded controller in real-time through a monitoring block and store information for grasping an abnormal symptom, anticipate possibility of occurrence of the abnormal symptom and allow a corrective action, provide a log for grasping a cause of a power failure when an error occurs in the power supplied to the PC-based embedded controller, and continuously monitor, store and confirm a system state even when the power supplied to the system is cut off or an error occurs in an operation of the OS since a battery is separately provided.

The other objects, specific advantages and new features of the present invention will be clarified further more from the following detailed descriptions and preferred embodiments in relation to the accompanying drawings.

### Solution to the Problem

To accomplish the above object, according to one aspect of the present invention, there is provided a smart monitoring apparatus provided in a PC system to monitor a state of a PC-based embedded controller, the apparatus including: a monitoring block for monitoring a state in the system and creating state information; a logging block for receiving the state information created by the monitoring block and storing the state information in a form of a log in real-time so that the stored log and current state information may be confirmed; and a battery for supplying power to the logging block when an operating system in the system does not operate or power supplied to the system is cut off.

The smart monitoring apparatus further includes a configuration block for setting a speed of at least a fan provided in the system and setting a temperature profile for the fan.

The monitoring block includes a temperature monitoring block connected to at least a temperature sensor provided in the system to create temperature state information of the system; a fan monitoring block for monitoring an operation state of at least a fan provided in the system and creating fan state information; and a power monitoring block for monitoring the power supplied to the system and creating power state information.

The smart monitoring apparatus further includes an alarm block connected to the monitoring block to execute an alarm function when a fan does not operate, or a temperature is higher than a preset temperature, or input power is in an abnormal state, based on the state information created by the monitoring block.

The smart monitoring apparatus further includes a battery control block provided between the logging block and the battery to control the battery to supply the power of the battery to the logging block when the system power is cut off.

The logging block is supplied with power from the battery and stores the state information transmitted from the monitoring block in nonvolatile memory in the form of a log when the power supplied to the system is cut off or the operating system does not operate.

The smart monitoring apparatus includes a USB serial connected to the logging block, and when a confirmation command is received, the USB serial transmits the log stored in the logging block and the current state information to a USB port provided in a host PC so that the log and the current state information may be confirmed through the host PC.

The smart monitoring apparatus includes a serial port connected to the logging block, and if the serial port receives the confirmation command when the operating system does not operate, the serial port transmits the log stored in the logging block and the current state information to an external serial port of an external PC so that the log and the current state information may be confirmed through the external PC.

The battery is a lithium secondary battery.

The smart monitoring apparatus further includes a configuration block for setting a monitoring interval of the monitoring block and a storage interval of the logging block.

The configuration block sets a speed of a fan or sets a temperature profile for an automatic fan speed mode, and the smart monitoring apparatus further includes a control block for controlling the speed of the fan based on the value set by the configuration block.

### Advantageous Effects of the Invention

According to an embodiment of the present invention, the smart monitoring apparatus may sense a state of a PC-based embedded controller in real-time through a monitoring block and store information for grasping an abnormal symptom, anticipate possibility of occurrence of the abnormal symptom and allow a corrective action, provide a log for grasping a cause of a power failure when an error occurs in the power supplied to the PC-based embedded controller, and continuously monitor, store and confirm a system state even when the power supplied to the system is cut off or an error occurs in an operation of the OS since a battery is separately provided.

Although the present invention is described in relation to a preferred embodiment as described above, those skilled in the art may easily recognize that various modifications and changes can be made without departing from the spirit and scope of the invention, and it is apparent that the modifications and changes are within the scope of the appended claims.

### BRIEF DESCRIPTION OF DRAWINGS

FIG. 1 is a block diagram mimetically showing a smart monitoring apparatus according to an embodiment of the present invention.

FIG. 2 is a block diagram further specifically showing a smart monitoring apparatus according to an embodiment of the present invention.

FIG. 3 is a flowchart illustrating an operation method of a smart monitoring apparatus according to an embodiment of the present invention.

### DESCRIPTION OF SYMBOLS

1: Host PC 2: External PC

10: Monitoring block 11: Fan monitoring block

12: Temperature monitoring block

13: Power monitoring block

20: Fan 21: First fan

22: Second fan 23: Third fan

30: Temperature sensor 31: First temperature sensor

32: Second temperature sensor 33: Third temperature sensor

40: Power supply block 41: 5V power

42: 12V power 50: Logging block

55: Battery 56: Battery control block

60: Configuration block 70: Control block

80: Alarm block 81: Alarm means

91: USB serial 92: Serial port

100: Smart monitoring apparatus

### DETAILED DESCRIPTION

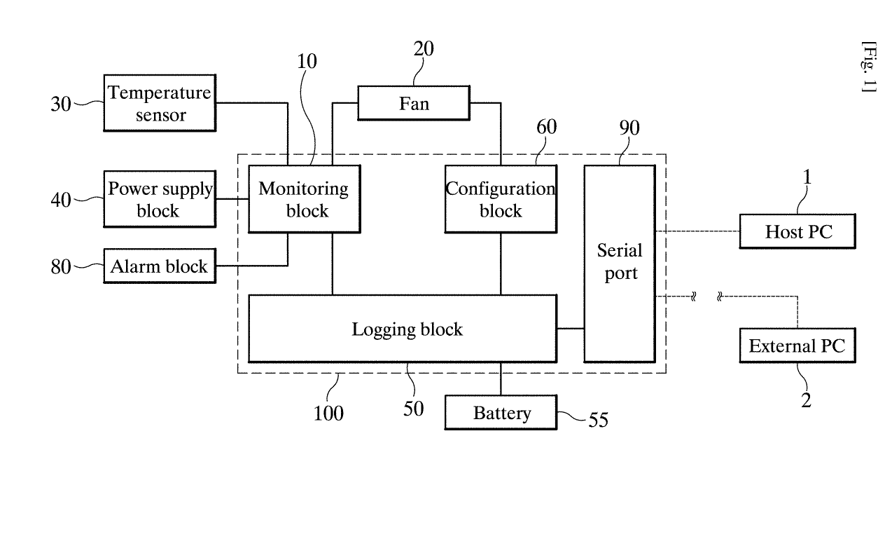

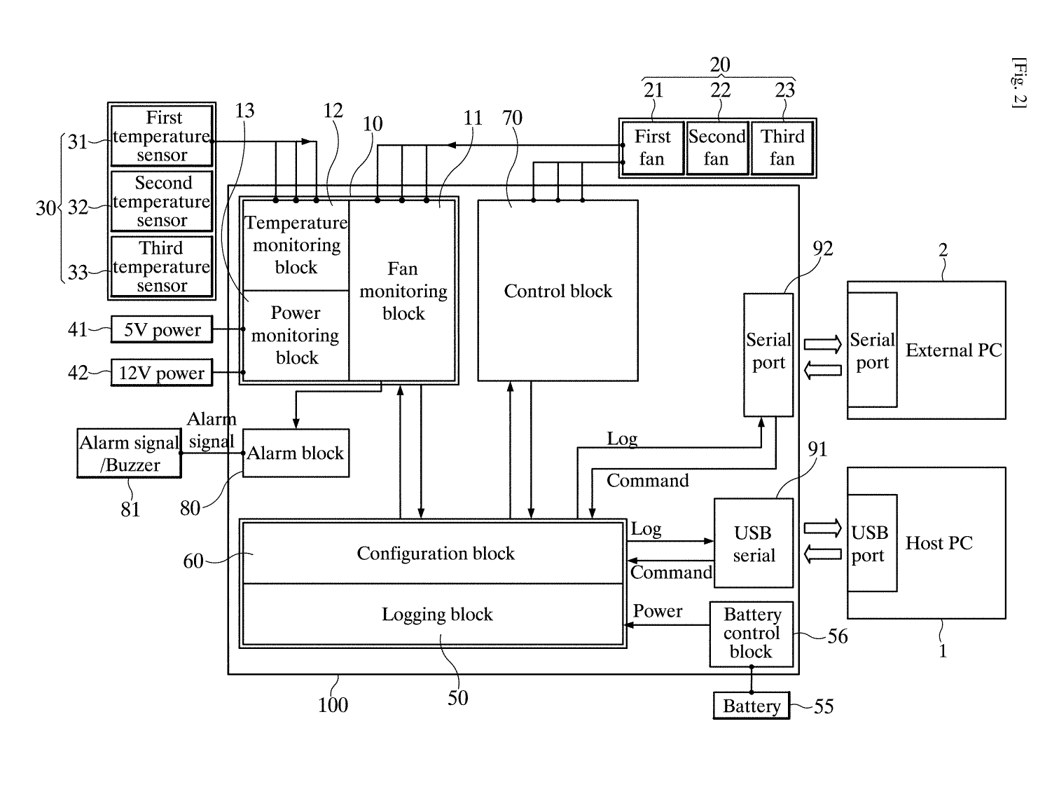

Hereinafter, the configuration and functions of a smart monitoring apparatus 100 according to an embodiment of the present invention will be described. First, FIG. 1 is a block diagram mimetically showing the smart monitoring apparatus 100 according to an embodiment of the present invention, and FIG. 2 is a block diagram further specifically showing the smart monitoring apparatus 100 according to an embodiment of the present invention.

As shown in FIGS. 1 and 2, the smart monitoring apparatus 100 according to an embodiment of the present invention is mounted inside a PC system and includes a monitoring block 10, a configuration block 60, a logging block 50, a control block 70 and a serial port 90.

The monitoring block 10 is connected to a plurality of temperature sensors 30, a plurality of fans 20 and a power supply block 40, monitors temperature values in the system, operation states of the fans 20 and power supplied to the system in real-time and creates state information.

Further specifically, as shown in FIG. 2, the monitoring block 10 includes a temperature monitoring block 12 for receiving a temperature value from each of the temperature sensors 30 in real-time, monitoring temperature in the system and creating temperature state information, a fan monitoring block 11 for monitoring an operation state and a speed value of each of the fans 20 installed in the system and creating fan state information, and a power monitoring block 13 for monitoring power supplied to the system and creating power state information.

For example, as shown in FIG. 2, if it is assumed that a first temperature sensor 31 and a second temperature sensor 32 for measuring temperature of the CPU and a third temperature sensor 33 for measuring temperature of a system case are installed in the system, the temperature monitoring block 12 receives temperature values from the first temperature sensor 31, the second temperature sensor 32 and the third temperature sensor 33 in real-time and creates the temperature state information. Although three temperature sensors 30 are provided in the system in an embodiment of the present invention, this is merely an embodiment, and a specific configuration, the number of temperature sensors or the like will not affect the scope of the present invention as long as the temperature monitoring block 12 may create the temperature state information.

In addition, as shown in FIG. 2, if it is assumed that a first fan 21 and a second fan 22 for cooling down the CPU and a third fan 23 for lowering temperature of the system case are installed in the system, the fan monitoring block 11, which is a component of the monitoring block 10, receives and monitors operation states of the fans 20 and current speed values of the fans 20 in real-time and creates the fan state information. In addition, as shown in FIG. 2, the power monitoring block 12, which is a component of the monitoring block 10, is connected to two powers supplied to the system, i.e., a 5V power 41 and a 12V power 42, monitors voltages of the supplied powers in real-time and creates the power state information.

Since the technical spirit of the monitoring block 10 according to an embodiment of the present invention lies in a monitoring work itself for monitoring the states of devices installed the system, the scope of the present invention will not be affected by the types and numbers of the devices installed in the system, and the present invention should not be interpreted by limiting the scope of claims to the embodiment and the drawings described above.

In addition, the smart monitoring apparatus 100 according to an embodiment of the present invention includes the logging block 50. As shown in FIG. 2, the logging block 50 receives the state information created by the monitoring block 10 and stores the state information in nonvolatile memory in real-time in the form of a log. That is, the logging block 50 receives the temperature state information created by the temperature monitoring block 12 and stores the temperature state information in the nonvolatile memory in the form of a log, receives the fan state information created by the fan monitoring block 11 and stores the fan state information in the nonvolatile memory in the form of a log, and receives the power state information created by the power monitoring block 13 and stores the power state information in the nonvolatile memory in the form of a log, in real-time at regular intervals.

In addition, the smart monitoring apparatus 100 according to an embodiment of the present invention includes an alarm block 80. As shown in FIG. 2, the alarm block 80 also receives the current state information from the monitoring block 10 in real-time. In addition, the alarm block 80 determines whether or not the current temperature is higher than a preset threshold temperature based on the temperature state information, whether or not the power is normal based on the power state information, and whether or not operation of the fans 20 has been stopped based on the fan state information, and when the temperature is higher than the preset threshold temperature, or the power is in an abnormal state, or operation of the fans 20 has been stopped, the alarm block 80 transmits an alarm signal to an alarm means 81 to inform a user of the problems. In a specific embodiment, the alarm means may be configured as a buzzer to inform the user of the abnormal state as a sound or may be configured as a display unit formed of LEDs to visually inform the user of the abnormal state.

In addition, the smart monitoring apparatus 100 according to an embodiment of the present invention is embedded with a battery 55 separated from an external power supply which supplies power into the system. The battery 55 is preferably formed as a lithium secondary battery as shown in an embodiment of the present invention. Accordingly, when the power is normally supplied to the system from the external power supply, the battery 55 is recharged using the supplied power.

In addition, a battery control block 56 is provided between the battery 55 and the logging block 50, and when an error occurs in the operating system (OS) or the power supplied to the system is cut off in the system, the battery control block 56 supplies power of the battery 55 to the logging block 50. Accordingly, although the operating system (OS) does not operate or the power supplied to the system is cut off in the system, the logging block 50 may receive the state information and store the received state information in the nonvolatile memory in the form of a log. In a specific embodiment, although the power supplied to the system is cut off, logging the state information can be continued for about three hours.

In addition, as shown in FIG. 2, the smart monitoring apparatus 100 according to an embodiment of the present invention includes the configuration block 60 and the control block 70. The configuration block 60 may manually set a speed of each of the fans 20 installed in the system and may set a temperature profile for an automatic fan speed mode. That is, the configuration block 60 sets a threshold temperature value for the temperature of the CPU or the case of the system and sets a speed for each of the fans 20 to lower the temperature below the threshold temperature value. Accordingly, these set values are transmitted to the control block 70, and the control block 70 controls each of the fans 20 based on the set values.

In addition, the configuration block 60 may set an interval of the monitoring block 10 for inputting and creating state information and an interval of the logging block 50 for receiving and storing the state information in the nonvolatile memory in the form of a log, as well as manually setting a speed of each of the fans 20 or setting a temperature profile for an automatic fan speed mode. In a specific embodiment of the present invention, the logging block 50 is set to store the received state information in the form of a log at intervals of one minute.

In addition, the smart monitoring apparatus 100 according to an embodiment of the present invention supports a user confirmation function, i.e., a log backup function. Specifically, since the smart monitoring apparatus 100 is provided with a USB serial 91, when a confirmation command is issued by a host PC 1, the confirmation command is transmitted to the USB serial 91 through a USB port mounted on the host PC 1, and the USB serial 91 transmits the log stored in the logging block 50 and the current state information to the host PC1 through the USB serial 91 and the USB port, and thus the host PC 1 may confirm the current state information and the stored log information. Accordingly, the user may confirm temperature in the system, speeds of the fans 20, operation states of the fans 20 and an abnormal state of the power through the host PC 1 in real-time, and thus when a problem occurs due to an abnormal state of the system, the user may analyze a cause of the problem.

In addition, the smart monitoring apparatus 100 according to an embodiment of the present invention supports the user confirmation function, i.e., the log backup function, even when the OS does not operate. Further specifically, since power of the battery 55 is supplied to the logging block 50 by the battery control block 56 even when the OS does not operate, the logging block 50 may continuously store the state information in the nonvolatile memory in the form of a log.

In addition, since the smart monitoring apparatus 100 according to an embodiment of the present invention is provided with a serial port 92 in addition to the USB serial 91, the current state information and the stored log can be transmitted to the serial port 92 even when the OS does not operate. Accordingly, when a confirmation command is issued from an external PC 2 separately existing at the outside, the confirmation command is transmitted to the serial port 92 provided in the smart monitoring apparatus 100 through an external serial port provided in the external PC 2, and the serial port 92 receiving the confirmation command transmits the current state information and the stored log received from the logging block 50 to the external PC 2, and thus the user may confirm the current state information and the stored log through the external PC 2. Accordingly, the user may determine a cause by confirming the stored log when a problem occurs due to an abnormal state of the system power.

Hereinafter, an operation method of the smart monitoring apparatus 100 according to an embodiment of the present invention will be described. The operation method described below is proposed as an embodiment which operates in an operation method of the smart monitoring apparatus 100 described above, and since the present invention specifies the scope of claims of an object itself, if an apparatus including all the configurations specified in the claims is used although some of the sequences are changed or omitted, it should be interpreted as being included within the scope of the present invention.

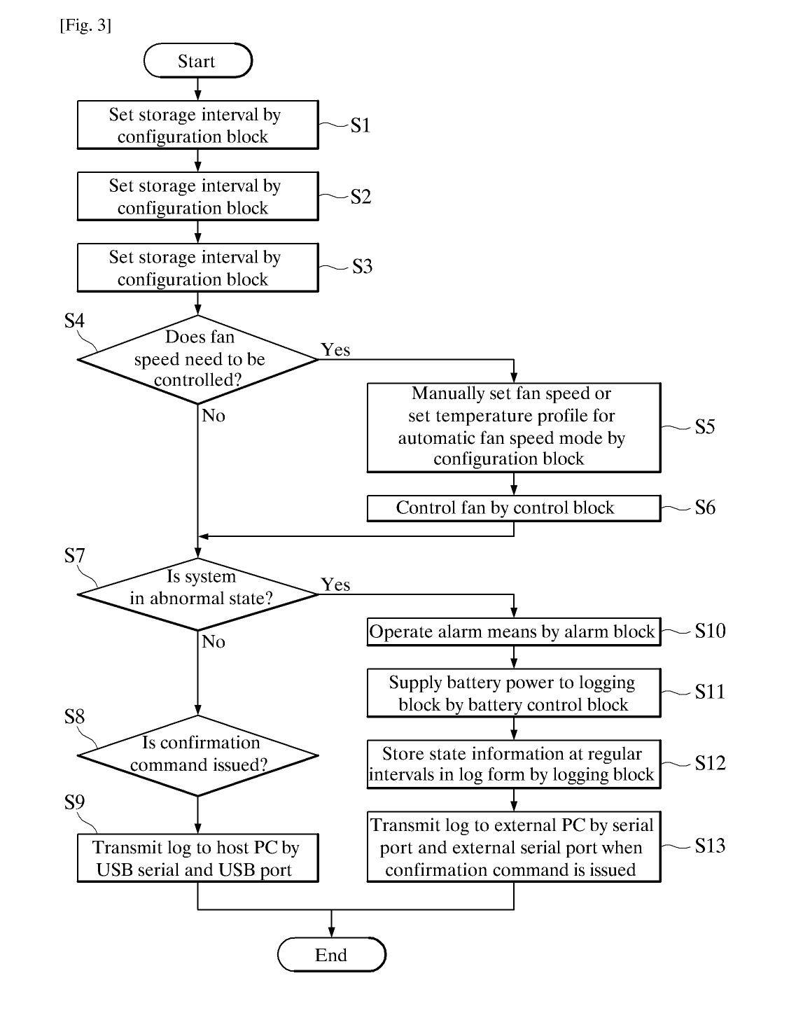

FIG. 3 is a flowchart illustrating an operation method of a smart monitoring apparatus 100 according to an embodiment of the present invention. First, the configuration block 60 of the smart monitoring apparatus 100 according to an embodiment of the present invention sets a storage interval of the logging block 50 S1. Then, the monitoring block 10 monitors operation states of a plurality of fans 20 installed in the system in real-time, monitors temperature in the system by receiving temperature values from the temperature sensors 30 and monitors power supplied to the system.

That is, as described above, the temperature monitoring block 12 receives temperature values from the temperature sensors 30 and create temperature state information based on the system temperature, and the fan monitoring block 11 creates fan state information based on the operation states of the fans 20, and the power monitoring block 13 creates power state information by monitoring the power S2. Then, the logging block 50 receives the state information from the monitoring block 10 at regular intervals (one minute in a specific embodiment) set by the configuration block 60 and stores the state information in nonvolatile memory in the form of a log S3.

Then, when the speed of the fans 20 needs to be controlled S4, a user may manually adjust the speed of the fans 20 through the configuration block 60 and may set a temperature profile for an automatic fan speed mode in the automatic fan speed mode S5. Then, the control block 70 controls the speed of the fans 20 based on the set value S6.

Then, when the user issues a confirmation command S8, the confirmation command is transmitted to the USB serial 91 provided in the smart monitoring apparatus 100 through the USB port of the host PC 1, and the USB serial 91 transmits the log stored in the logging block 50 and the current state information through the USB port of the host PC 1 S9. Accordingly, the user may confirm the current state information and the log of the system through the host PC 1, and when the system is in an abnormal state, the user may analyze a cause of the abnormal state by confirming the current state information and the log.

In addition, when the system is in an abnormal state S7, i.e., when the temperature is higher than a set threshold temperature, or the fans 20 do not operate, or the system power is cut off, or the operating system does not operate, the alarm block 80 receiving the state information transmits an alarm signal to the alarm means 81 to inform the user that an abnormal state has been occurred in the system S10.

Then, when the system power is cut off or the operating system does not operate, the battery control block 56 supplies power stored in the battery 55 to the logging block 50 S11. Accordingly, the logging block 50 may continuously store the state information created by the monitoring block 10 even in such a situation S12.

In addition, even when the system power is cut off or the operating system does not operate, if a user of the external PC 2 issues a confirmation command through the external PC 2, the confirmation command is transmitted to the serial port 92 provided in the smart monitoring apparatus 100 through an external serial port provided in the external PC 2, and the serial port 92 transmits the log stored in the logging block 50 and the current state information to the external serial port S13. Accordingly, the user of the external PC 2 may confirm the log and the current state information even when the system power is cut off or the operating system does not operate, and when a problem such as an abnormal state of the system power occurs, the user may analyze a cause of the problem.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A smart monitoring apparatus provided in a PC system to monitor a state of a PC-based embedded controller, the apparatus comprising: a monitoring block for monitoring a state in the system and creating state information; a logging block for receiving the state information created by the monitoring block and storing the state information in a form of a log in real-time so that the stored log and current state information may be confirmed; a battery for supplying power to the logging block when an operating system in the system does not operate or power supplied to the system is cut off; a battery control block provided between the logging block and the battery to control the battery to supply the power of the battery to the logging block when the system power is cut off; a configuration block for setting a monitoring interval of the monitoring block and a storage interval of the logging block, setting a speed of a fan provided in the system, or setting a temperature profile for an automatic fan speed mode; and a control block for controlling the speed of the fan based on the value set by the configuration block, wherein the logging block is supplied with power from the battery and stores the state information transmitted from the monitoring block in nonvolatile memory in the form of a log when the power supplied to the system is cut off or the operating system does not operate, and since a USB serial connected to the logging block is included, when a confirmation command is received, the USB serial transmits the log stored in the logging block and the current state information to a USB port provided in a host PC so that the log and the current state information may be confirmed through the host PC, and since a serial port connected to the logging block is included, if the serial port receives the confirmation command when the operating system does not operate, the serial port transmits the log stored in the logging block and the current state information to an external serial port of an external PC so that the log and the current state information may be confirmed through the external PC.

2. The apparatus according to claim 1, wherein the monitoring block includes: a temperature monitoring block connected to at least a temperature sensor provided in the system to create temperature state information of the system; a fan monitoring block for monitoring an operation state of at least a fan provided in the system and creating fan state information; and a power monitoring block for monitoring the power supplied to the system and creating power state information.

3. The apparatus according to claim 2, further comprising an alarm block connected to the monitoring block to execute an alarm function when a fan does not operate, or a temperature is higher than a preset temperature, or input power is in an abnormal state, based on the state information created by the monitoring block.

4. The apparatus according to claim 1, wherein the battery is a lithium secondary battery.
